(19) United States
(12) Patent Application Publication
(10) Pub. No.: US 2013/0181101 A1
(43) Pub. Date: Jul. 18, 2013

(54) FLEXIBLE SUPPORT FOR TABLET-STYLE COMPUTERS

(71) Applicant: Meir Avganim, Gealya (IL)

(72) Inventor: Meir Avganim, Gealya (IL)

(21) Appl. No.: 13/722,344

(22) Filed: Dec. 20, 2012

Related U.S. Application Data
(60) Provisional application No. 61/579,894, filed on Dec. 23, 2011.

(51) Int. Cl. F16M 13/02

(52) U.S. Cl. CPC F16M 13/02
USPC 248/205.1

(57) ABSTRACT

A support system for computer devices such as tablet-style computers, comprises a base that can be screwed or bolted to a stationary object or which can be attached to a person's body with straps. The base provides a hinge, and extendible arm which supports the base to which the tablet-style computer is affixed, either immovably or rotatably. The support system allows a person to use a tablet-style computer without having to hold it in one's hand and with the hands being free for quickly switching between use of the computer and other tasks.

### CROSS REFERENCE TO RELATED APPLICATIONS

The present application claims the benefit of U.S. Provisional Patent Application No. 61/579,848 filed on Dec. 23, 2011; which is incorporated herein by reference in its entirety.

### BACKGROUND OF THE INVENTION

The present invention is generally directed to a support system for computer devices and, more particularly, to a flexible support for tablet-style computer which allows it to be supported to any stable object or to a wall or even to a person on the move.

Handheld devices, particularly tablet-style personal electronic devices, have become very popular. These devices often require the use of both hands, particularly when trying to enter data and manipulate screens. It is difficult to hold these devices in both hands, particularly for prolonged periods. Also, for people on the go, it is desirable to be able to quickly shift between using the hands for different tasks and then use the tablet-style personal computer while moving around one's home, office or the like.

### SUMMARY OF THE INVENTION

It is an object of the present invention to provide a support for tablet-style or similar electronic devices which is capable of supporting the electronic device flexibly and with great versatility.

The foregoing and other objects of the invention are realized with a support system for computer devices such as tablet-style computers which comprises a base that can be screwed or bolted to a stationary object or which can be attached to a person's body with straps. The base provides a hinged, extendable arm which supports a base to which the tablet-style computer can be affixed, either immovably or rotatably. The hinged arm can be pivoted between angles from 0 to greater than 180° and allows a user of the support system to use the tablet without having to hold it in one's hands and with having the hands free for quickly switching between use of the computer and other tasks.

Other features and advantages of the present invention will become apparent from the following description of the invention which refers to the accompanying drawings.

### BRIEF DESCRIPTION OF THE DRAWINGS

FIG. 1 is a perspective of the invention showing the device in use in an extended position.

FIG. 2 is another perspective showing the tablet in a less extended position.

FIG. 3 is a third perspective of the invention showing the tablet at a different angle and with shoulder and body straps attached to its base.

FIG. 4 shows the perspective of FIG. 3 with the tablet in an extended position.

FIG. 5 is a perspective of the tablet-style computer support system showing the tablet in a stowed position.

FIG. 6 is another perspective, similar to FIG. 5.

FIG. 7 shows the tablet support system in a landscape embodiment.

### DETAILED DESCRIPTION OF THE DRAWINGS

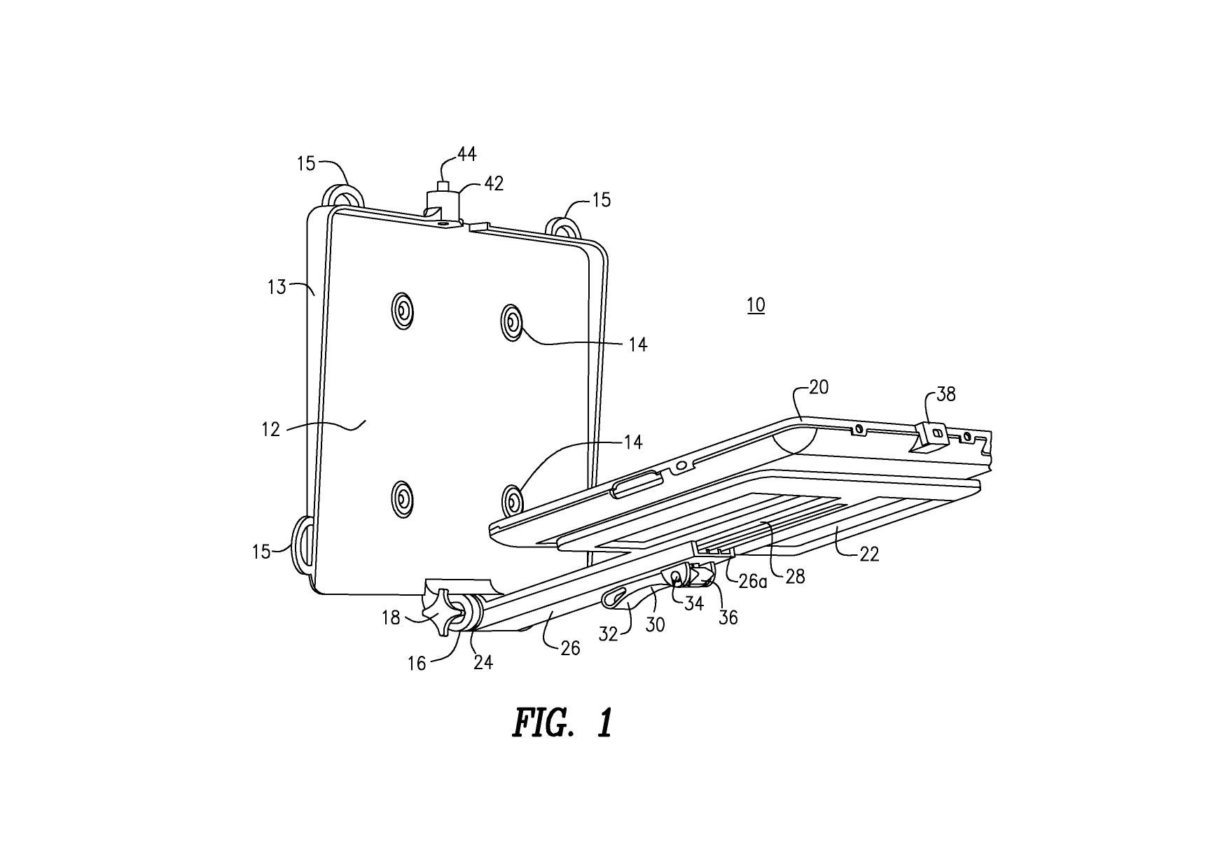

Referring to FIG. 1, the tablet support 10 comprises a base 12 with screw or bolt openings 14 defined therein by which it can be affixed to a stationary object such as a desk, a wall or the like. The base is flanked by left and right side walls 13.

At the bottom or one side of the support base 12 is a hinge mechanism 16 with a knob 18 which allows the supporting arm 26 to pivot between a closed position, at which the arm is substantially parallel to the base 12 and an open position, the angle of which can be adjusted at various angles, at least from 0 to 180° and even at greater angles. Ridging 24 provided inside the hinge 16 allows the angular position of the arm to be firmly supported. A slide 28 extends in the trough 26a of the arm 26 and is slidable inside said trough toward and away from the base 12. The slide 28 supports a tablet base or platform 22 which can be affixed by a Velcro® connection to the tablet-style computer 20 or by a centrally located pivot that allows the tablet 30 to rotate clockwise and counter-clockwise about a center of the tablet base 22.

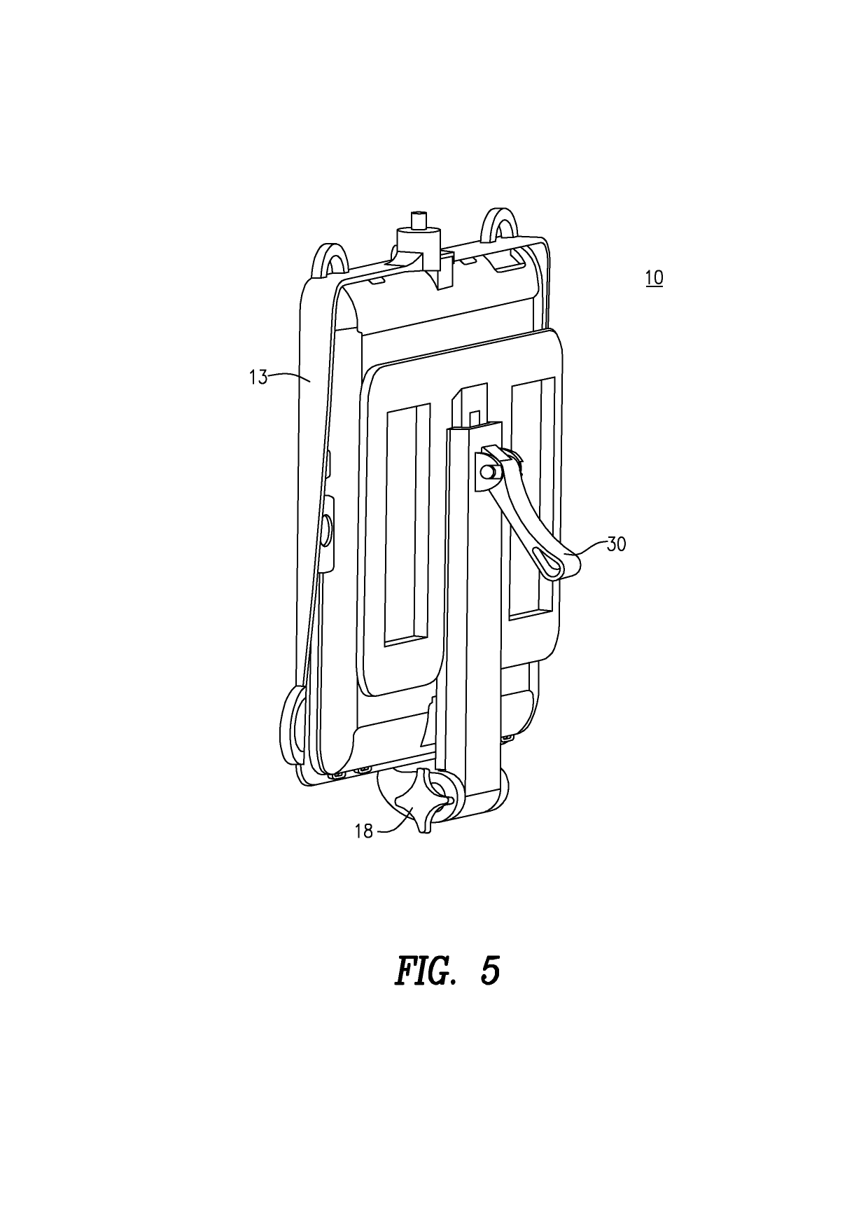

In the stowed position shown in FIG. 5, a locking tab 38 on the tablet 20 engages a lock 42 located near the top of the base 12, which has a pin 44 that engages an opening in the tab 38.

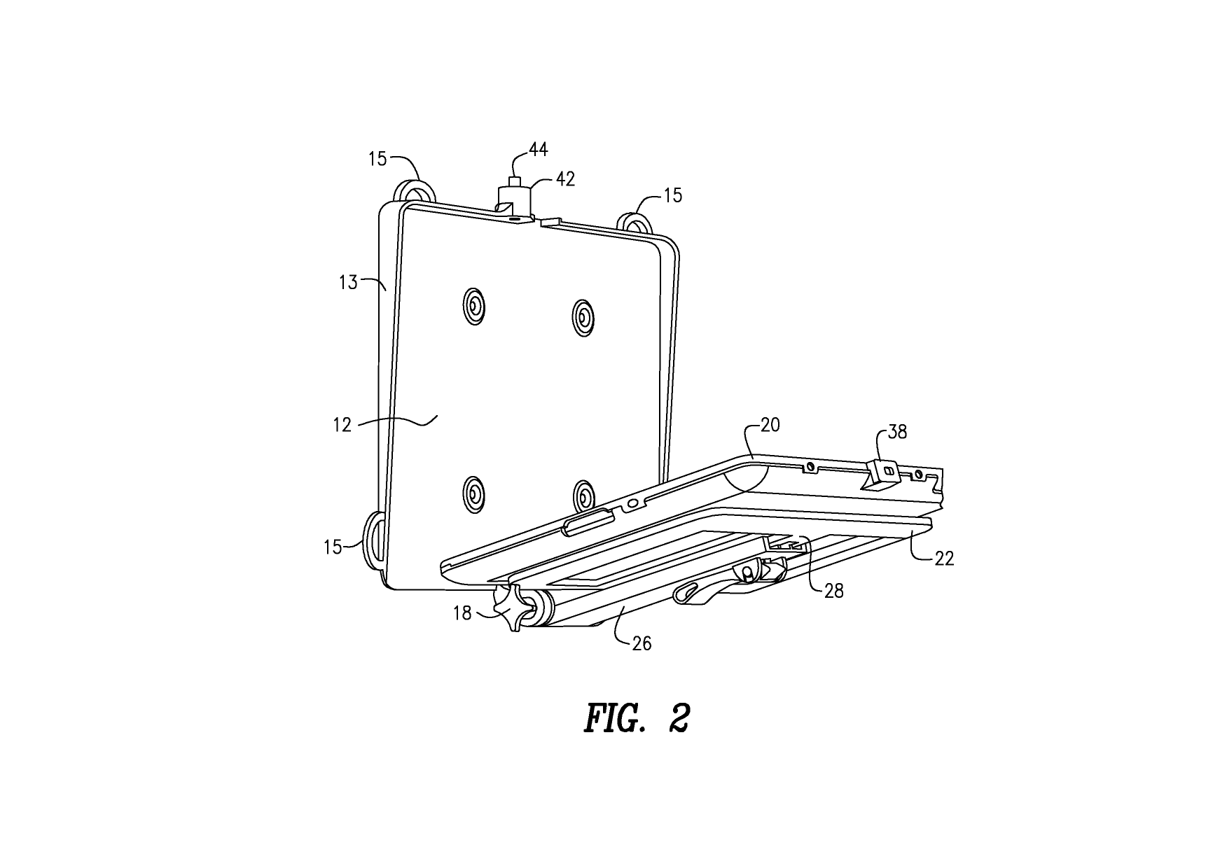

In FIG. 2, the tablet 20 is shown in a position where it is slid closer to the base 12. In FIG. 1, the sliding position of the tablet can be affixed by operating the lock 30 which has a pivotable lever 32 that is hinged at the pivot 34 and which is provided with a cam 36, which bears against the slide 28 to fix its sliding position.

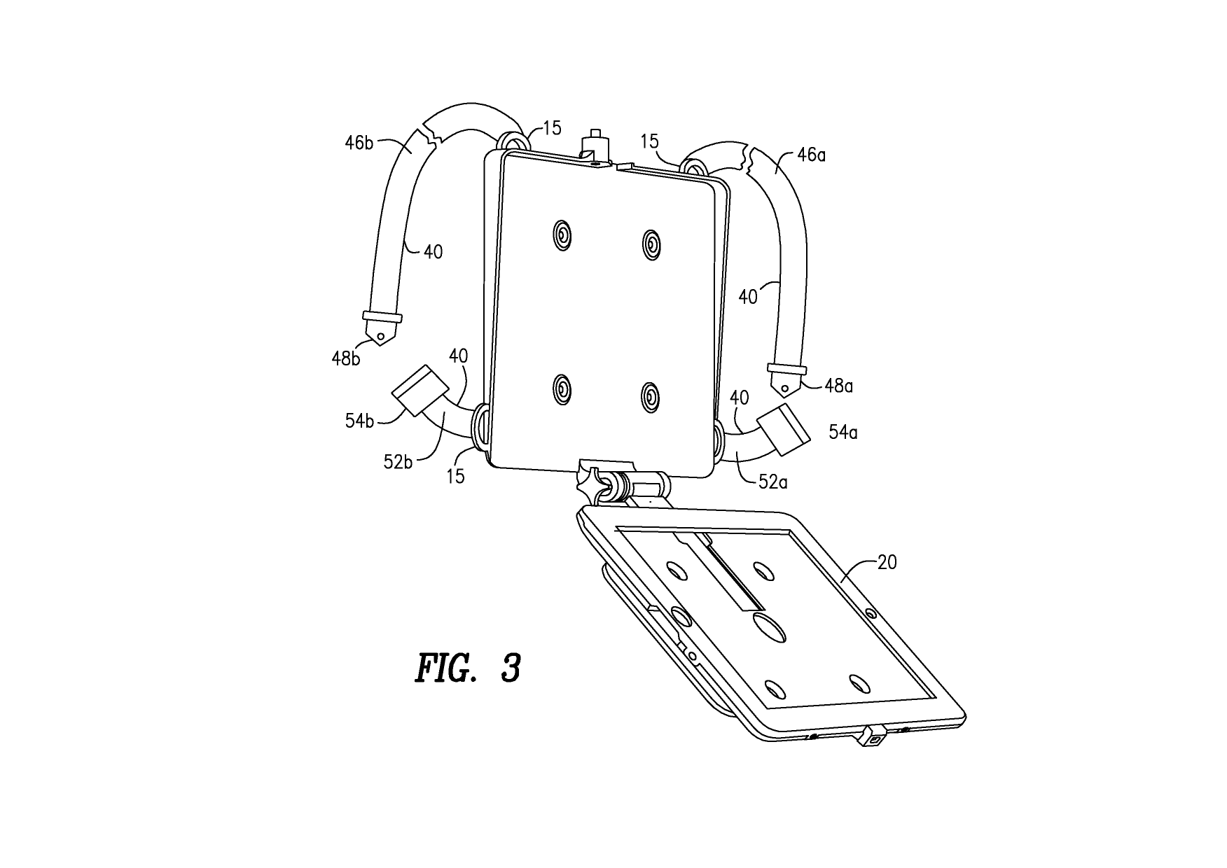

In FIG. 3, the tablet-style computer 20 has been pivoted at an angle greater than 90°, which might be very comfortable for a situation where the support 12 is mounted to a wall or to a desk. However, as shown in FIG. 3, the slotted flanges 15 at the four corners of the base 12 can be threaded with straps 40. The straps 40 include upper straps 46a and 46b and lower straps 52a and 52b. The lower straps have female car seat-style locks 54a, 54b which receive corresponding male locks 48a and 48b, enabling the base 12 and supported tablet-style computer to be strapped to a person's body in an easily recognizable manner. The two straps 46a and 46b can be crossed to prevent rotation of the support 10 about a person's body.

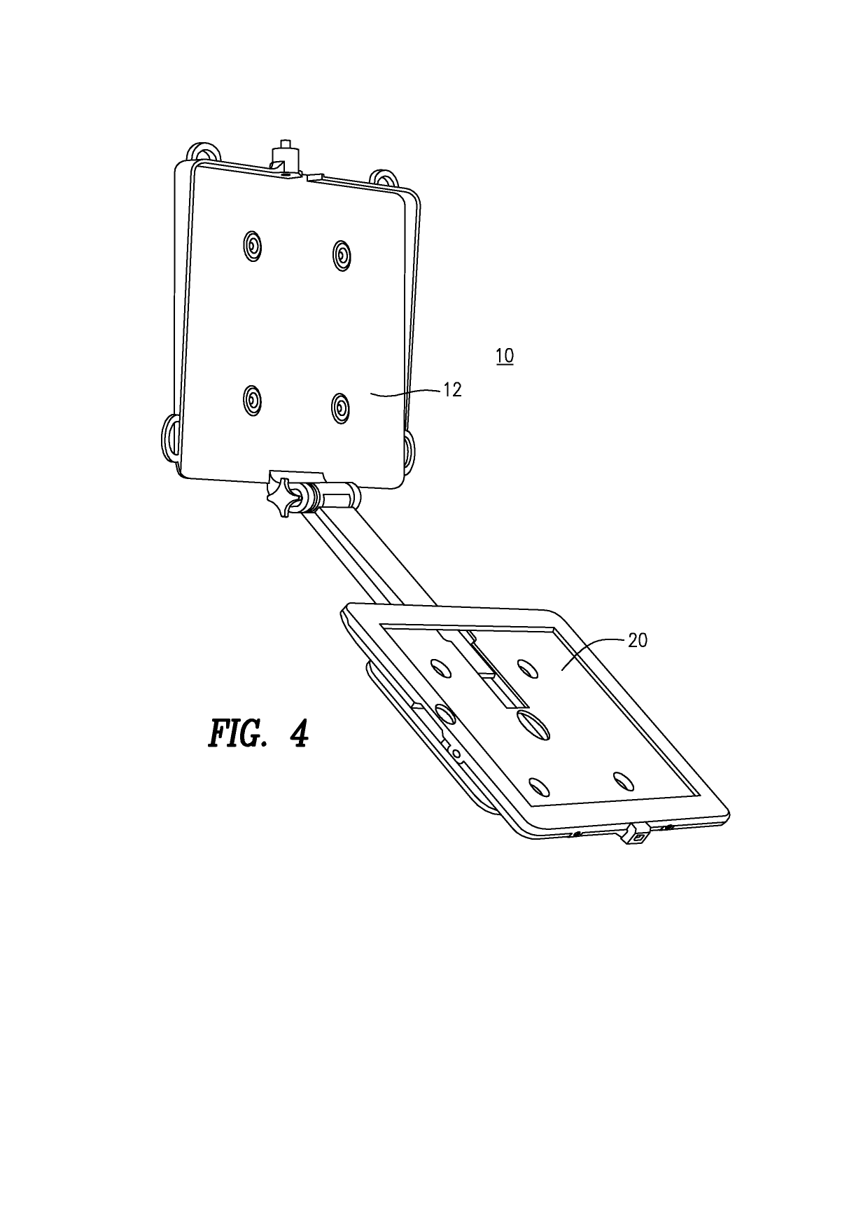

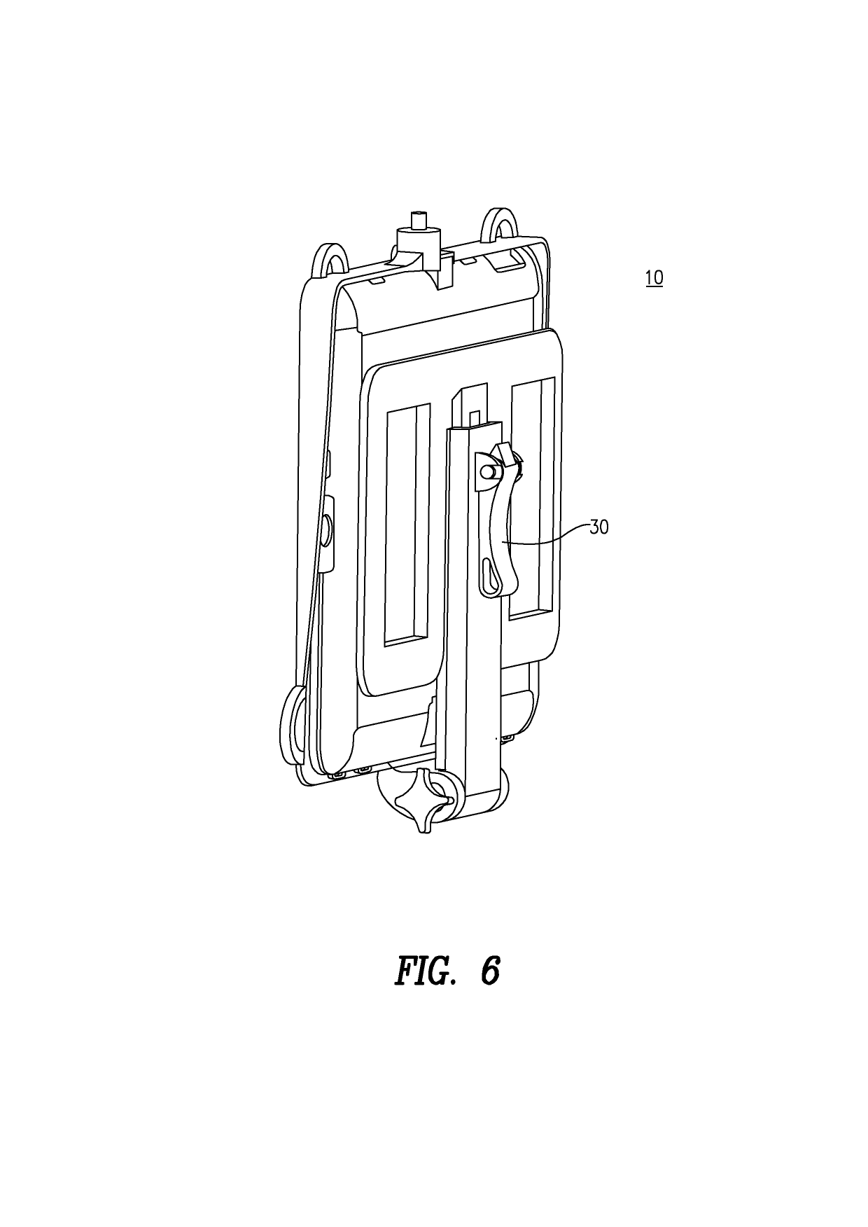

FIG. 4 is similar to FIG. 3, except that it shows the tablet 20 in a further extended location. FIG. 5 shows the stowed position with the securing lever untightened, whereas FIG. 6 shows the securing lever 30 in the tightened position.

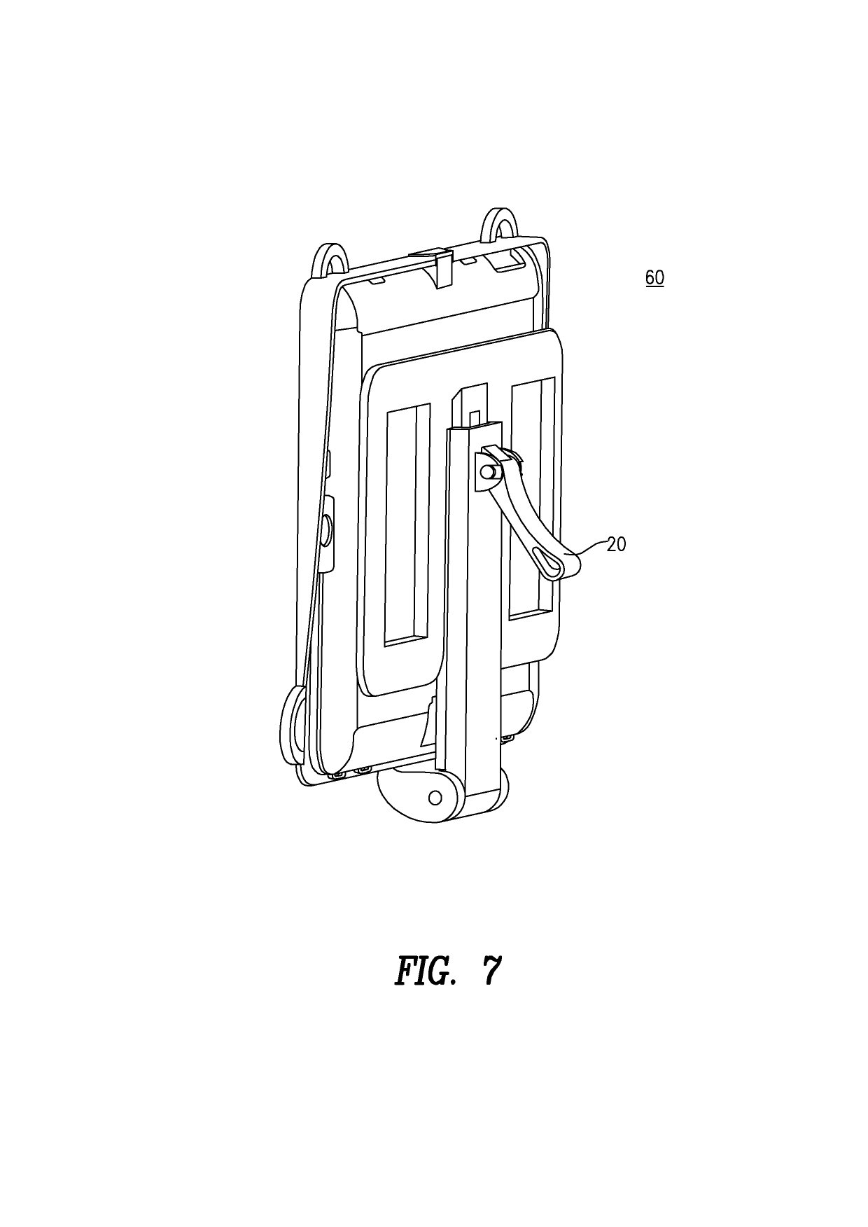

In FIG. 7, the base 12 has been formed similar to the previously described embodiments, but in a landscape position, so that it is a shorter in height, but with somewhat greater width in accordance with an embodiment of the invention.

Although not shown, the arm 26 (in FIG. 1) can be made to have a telescopic construction, so that it can provide an even greater degree of extendibility.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A flexible support for tablet-style computers, the support comprising:
a base;
a strap system attached to the base and configured to allow the base to be worn against the chest of a person with the strap extending at least partially around the back of the person;
a hinge mechanism attached to the base;
a supporting arm attached to the hinge mechanism of the base and pivotable between a closed position, at which the arm extends substantially parallel to the base, and an open position, at which arm extends at an adjustable angle relative to the base; and
a tablet platform supported on the supporting arm and configured to hold a tablet-style computer.

2. The support of claim 1, wherein the arm is adjustable at angle from about 0° to 180° relative to the base.

3. The support of claim 1, including ridging provided inside the hinge mechanism to allow the angular position of the arm to be firmly supported.

4. The support of claim 1, including a slide associated with the arm and the tablet platform being coupled with the slide to enable the tablet platform to move closer and further away from the hinge mechanism.

5. The support of claim 1, including a hook and loop connection for attaching the tablet-style computer to the tablet platform.

6. The support of claim 1, further including a locking tab for securing the tablet to tablet platform.

7. The support of claim 1, including a fastening mechanism that enables fastening of the base to a piece of furniture.

8. The support of claim 1, wherein the strap system includes lower straps and upper straps.

9. The support of claim 1, wherein the base has height and width dimensions and the width dimension is greater than the height dimension.

10. The support of claim 1, wherein the base has height and width dimensions and the width dimension is smaller than the height dimension.
